(19) United States
(12) Patent Application Publication
(10) Pub. No.: US 2009/0121100 A1
(43) Pub. Date: May 14, 2009

(54) Length adjustable support

(75) Inventors: Werner Waidelich, Neuweiler (DE); Horst Schober, Neuweiler (DE)

Correspondence Address: KOHLER SCHMID MOEBUS, RUPPMANNSTRASSE 27, D-70565 STUTTGART, DE

(73) Assignee: VEYHL GmbH, Neuweiler (DE)

(21) Appl. No.: 12/292,077

(22) Filed: Nov. 12, 2008

(30) Foreign Application Priority Data
Nov. 14, 2007 (DE) 10 2007 054 192.0

(51) Int. Cl. F16M 11/26; A47B 91/02

(52) U.S. Cl. 248/188.4; 108/146

(57) ABSTRACT

Proposed is a length-adjustable, in particular, height-adjustable support 1 with a tube profile 4 preferably designed as cylinder profile, a telescopic support column 8 guided in the tube profile 4, and a spindle rod 11 which is guided in the support column 8 via a motion thread and mounted in a rotatable manner in the tube profile 4 in a free end area of the spindle rod 11, projecting out of the support column 8, and secured against axial displacement relative to the tube profile 4 via locking means. Locking means 25 are designed to block the radial rotatability of the spindle rod relative to the tube profile 4.

This application claims Paris Convention priority of DE 10 2007 054 192.0 filed Nov. 14, 2007 the complete disclosure of which is hereby incorporated by reference

### BACKGROUND OF THE INVENTION

The invention relates to a length-adjustable, in particular, a height-adjustable support with a tube profile and a telescopic support column guided inside the tube profile.

Pieces of furniture such as tables or office chairs must often be adjustable in height, e.g. the tabletop or seating surface. Towards this end, the table legs can, for example, be designed in a length-adjustable manner as telescopic supports. Locking means are provided for fixing the extended position of the support column and thereby the height of the support and to secure the support column with respect to the tube profile at its longitudinal extension in a set, extended position. For example, a splint is often inserted in bores provided along the longitudinal extension of the support.

It is furthermore known that the support column itself is designed as a spindle with a thread. The length adjustment can be implemented by unscrewing the spindle from the tube profile. There are no locking means required, since the thread of the spindle is guided in a self-locking manner in the tube profile.

To simplify the length adjustability, elastic elements are often provided within the support to facilitate extension, which exert a force pressing the support column out of the tube profile which is often designed as a cylinder profile. It is thereby much easier to adjust the support against gravity. Such facilitations of extension also secure these supports against unintentional shortening, i.e. slipping through, in the case of accidental release of the respective locking, i.e. in the case of accidental release of the length adjustment.

The known supports, in particular, in the mounted state, e.g. those of a table, are often characterized by their adaptation mechanism and their operation is partly quite complicated. It is often the case that several persons are required for the height adjustment. Due to their design, the elastic facilitations of extension are susceptible to wear and provide only limited support.

The task of this invention is to provide a length-adjustable support which avoids the disadvantages of prior art by achieving simple operability and a robust, virtually wear-free design of the support using simple measures.

### SUMMARY OF THE INVENTION

This task is solved by the elements of the patent claims. The dependent claims represent preferred embodiments of the invention.

A length-adjustable, in particular, height-adjustable support according to the invention has a tube profile preferably designed as cylinder profile, with a telescopic support column guided inside the tube profile. Alternatively, other polyangular cross-sectional forms such as triangular, quadrangular or rectangular can be used according to the invention.

According to the invention, a spindle rod is provided, which is guided inside the support column via a motion thread. The support column forms a guide column together with the tube profile. The spindle rod is mounted in a free end area of the spindle rod protruding out of the support column, is secured against axial displacement relative to the tube profile by securing means, and is mounted in a rotatable manner in the tube profile. The spindle rod can be screwed into the support column without the tube profile rotating with it, via a mating thread to the spindle rod, i.e. it is mounted rotatable in the radial direction.

The thread of the spindle rod is thereby screwed into the mating thread of the support column. The thread and mating thread are designed as motion threads. Such a motion thread is not self-locking, i.e. by pulling the spindle rod out of or pressing it into the support column, the thread and mating thread automatically rotate against each other, without a screwing motion having to be implemented from the outside on the spindle rod or on the support column.

According to the invention, locking means are provided, which are designed to block the radial rotatability of the spindle rod relative to the tube profile. By blocking the radial rotatability of the spindle rod, the spindle rod can no longer screw further into or out of the mating thread in the support column. The total length of the support according to the invention given by the position of the spindle rod set by the blocking thus remains fixed. These locking means can, for example, be latching devices, limit stops, screw buttons or push buttons.

A rotatability of the support column within the tube profile can be prevented in the support according to the invention by mounting parts which are in supporting engagement with another, e.g. a tabletop with respect to the floor, which do not rotate with respect to each other, i.e. rotation-resistant. In the case of a tabletop, this is already the case when there are several table legs provided to support the tabletop.

The locking according to the invention of the rotary motion of the motion thread of the spindle rod for height adjustment of the support, i.e. for locking the extended position of the guide column, allows for simple and reliable length adjustment of the support. The length adjustment mechanism formed by the spindle rod with a motion thread and the support column is virtually wear-free and very robust. Elastic facilitations of extension which impede slipping through are replaced by the fact that the screwing-in and unscrewing, respectively, of the spindle rod into/out of the support column of the support, which is required for length adjustment of the support according to the invention, impedes an insertion of the support column into the tube profile. For the case of use of the support according to the invention as, for example, a table leg, this slows down a slipping through to the bottom.

Preferably, at least one indentation is provided in the end area on the outer circumference of the spindle rod or of a latching element mounted in a rotation-resistant manner in the end area of the spindle rod. The blocking of the rotatability of the spindle rod is thereby achieved via at least one pin provided on at least one of the locking means which snaps into the indentation. When rotating the spindle rod by drawing it out of or pressing it into the support column, the pin can snap into the respective next indentation of the locking disk and thus block the rotatability of the spindle rod. This allows for a locking option in freely selectable locking dimensions, i.e. length adjustment steps. The length adjustment steps are only determined and limited by the slope of the motion thread and the distance of neighboring indentations. Since motion threads have a slope ratio suitable for the application according to the invention (e.g. slope 20 mm) and the distances between the indentations can be selected almost freely by their number, a virtually stepless length adjustment of the support according to the invention can be achieved. When using the support according to the invention as a table leg, the height adjustment range from 620 to 850 mm demanded in the standard NEN2449 can be exceeded, since no gratings or slots are required, in particular, in the tube profile.

Particularly advantageously, the locking means have an elastic element mounted in a rotation-resistant manner in the tube profile, which can be elastically deformed by activating a trigger, preferably protruding out of the tube profile, in such a way that, due to be elastic deformation of the element, the pin can be unlatched from the indentation for releasing the rotatability of the spindle rod in the tube profile. The length and height, respectively, of the support according to the invention can thereby be set via a simple elastic deformation of the locking means and without any tools. Thus, for example, the height adjustment of a table with table legs comprising a support according to the invention can easily be accomplished by one person only.

The elastic element is most preferably designed as a ring element and arranged radially around the free end area of the spindle rod. The trigger is designed as a lever extension provided on the ring element for widening of the inner circumference of the ring element, the pin being positioned on the inner circumference side of the ring element, protruding radially inwards, in such a way that the pin can be unlatched from the indentation to permit rotation of the spindle rod when the ring element is windened. By releasing the trigger, the inner circumference of the ring element is automatically reduced due to its elasticity, pressing the pin toward the outer circumference of the locking disk or the spindle rod itself so that this automatically latches into the next indentation when turning the spindle rod by pulling it out of or pressing it into the support column, thus blocking the rotatability of the spindle rod.

The geometry of the pins and/or the locking disk, in particular the indentation, can be chosen such that in the case of an unloading of the support according to the invention, i.e. a tensile loading of the support, an automatic release of the locking means is achieved and/or in the case of loading (i.e. a pressure loading of the support) an automatic locking of the locking means is achieved. For automatic releasing, in particular, the pins on the top, i.e. on the side facing away from the support column, can be slanted in a ramp-like fashion so that the ring element is widened due to the tensile loading. Thus, there is no adaptation mechanism for length adjustment required which is visible from the outside and disturbs the design of, for example, a table.

Particularly advantageously, the locking means have a bore through which the spindle rod is guided and a locking ring which prevents a pushing-out of the spindle rod from the bore at the free end of the end area of the spindle rod. The spindle-side end of the end area on the spindle rod provides a supporting edge which blocks a pushing-in of the spindle rod into the bore. Thus, a simple and robust securing of the spindle rod against axial displacement relative to the tube profile can be achieved. If a sliding washer is provided between the supporting edge and the locking means, the friction between the spindle rod and the locking means is minimized so that the free movement of the screwing motion of the spindle rod when pulling in and/or out the support according to the invention is improved.

If the tube profile is designed as a telescopic inner profile in an outer profile, preferably via sliding guides or rolling element guides, the outer form of the support according to the invention, in particular, with regard to its circumference, can be independent of the thickness of the height adjustment mechanism according to the invention, in particular, the thickness of the spindle rod and the diameter of the support column. The smallest inner geometry, i.e. the minimum required inner diameter of the inner profile corresponds to the outer diameter of the support column.

When a spindle nut is used as a guide for the spindle rod in the support column, this corresponds to the outer diameter of the spindle nut.

The support column is preferably designed in a substantially rotation-resistant manner with respect to the tube profile. Therefore, no outer elements are required to provide the rotation-resistance of the support column relative to the tube profile. The support according to the invention can then also be used as a single table leg, e.g. for a round bar table.

The rotation-resistant guide of the support column in the tube profile can be easily achieved via a rotation-resistant guide of the inner profile in the outer profile and a rotation-resistant fixing of the outer profile to the support column.

A table according to the invention has at least one table leg according to the invention. The locking means of the support are preferably positioned in an area of the table leg adjoining the tabletop so that they are easily accessible by a person without interfering with the design of the table leg.

The pin(s) of the ring element can thereby be designed such that, in the case of pressure load being applied on a tabletop, it or they wedge more severely in one or several indentations of the locking disk, thus additionally securing the selected height adjustment of the length-adjustable support.

The invention is described below in more detail on the basis of an embodiment with reference to the drawings.

### BRIEF DESCRIPTION OF THE DRAWING

FIG. 1 shows a cross section of a support according to the invention designed as a table leg.

FIG. 2 shows an embodiment of the locking means for blocking the rotatability of the spindle rod of a support according to the invention in an exploded view.

FIG. 3 shows another embodiment of a support according to the invention with the mechanism for locking the rotatability of the spindle rod shown in FIG. 2.

### DESCRIPTION OF THE PREFERRED EMBODIMENT

The figures of the drawings show the object according to the invention strongly schematized and are not to be taken to scale. The individual components of the object according to the invention are represented such that their design can be easily seen.

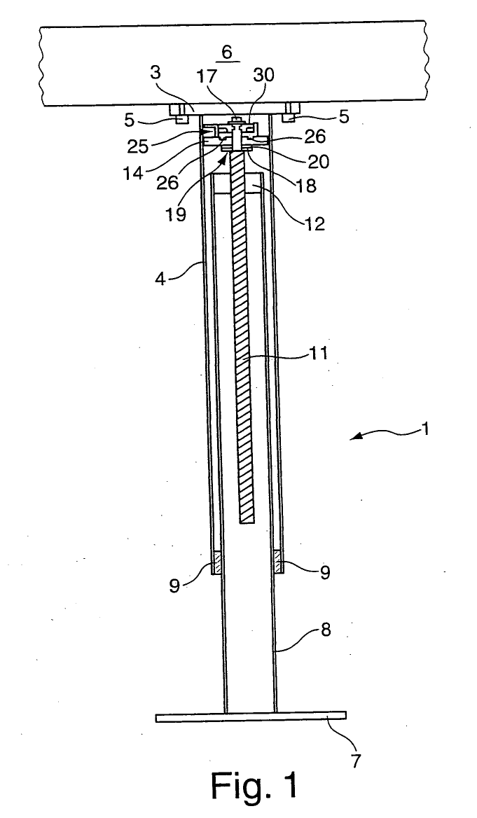

FIG. 1 shows a support 1 according to the invention designed as a table leg. The support 1 has a fixing plate 3 at its upper end, being fixed to the free upper end of the tube profile 4 of the support 1. The fixing plate 3 is mounted to a tabletop 6 via screws 5. A ground plate 7 is provided at the lower end of the support 1 by means of which the support 1 or the table leg stands on the floor when the table is mounted. The ground plate 7 is mounted to the free lower end of a support column 8 of the support 1.

The support column 8 is telescopic and guided in the tube profile 4 via sliding guides 9. Among numerous other guide options, the support column 8 can alternatively also be guided in the tube profile 4 via a rolling element guide. A spindle rod 11 is arranged in the support column 8 so that the support column 8 forms a spindle rod surrounding the spindle rod 11. The spindle rod 11 has a motion thread, e.g. a trapezoidal thread. Via this motion thread, the spindle rod 11 is guided in the support column 8 such that it can be screwed in and out. Towards this end, a spindle nut 12 is mounted in a rotation-resistant manner at the free upper end of the support column 8, with a mating thread to the thread of the spindle rod 11 on the support column 8 (secured against a rotation with respect to the support column 8).

A support plate is mounted in the tube profile 4 in a rotation-resistant manner as a spindle mating part 14 and is secured against displacement in the longitudinal direction of the support 1, e.g. welded to the inner wall of the tube profile 4. The support plate has a bore in the center into which a free upper end area of the spindle rod 11 protruding out of the support column 8 is inserted or pushed through. The spindle rod 11 is guided through the bore at the free end area and thus mounted in a radially rotatable manner in the tube profile 4.

The free end area of the spindle rod 11 is secured against axial displacement relative to the tube profile 4 via locking means. These locking means comprise a locking ring 17 which prevents a pushing-out of the spindle rod 11 from the boring at the free end of the end area of the spindle rod 11, and a locking disk 18 seating on a supporting edge 19 provided on the spindle-side end of the end area of the spindle rod 11. The supporting edge 19 blocks further insertion of the spindle rod 11 into the bore. A sliding washer 20 is provided between the locking disk 18 and the support plate to reduce the friction and thus the rotational resistance when turning the spindle rod 11.

Locking means 25 are provided in an area directly adjacent to the bottom of tabletop 6 within the tube profile 4 and serve for blocking the radial rotatability of the spindle rod 11 relative to the tube profile 4. After a blocking of the locking means 25, the spindle rod 11 can no longer rotate in the support column 8 when the tube profile 4 is secured in a substantially rotation-resistant manner with respect to the support column 8, like e.g. a table standing on a floor with two table legs, thus fixing a set length of the support 1, e.g. the height of the table.

The locking means 25 are attached to the support plate in a rotation-resistant manner via pins 26. A locking element 30 designed as a locking disk is fixed to the spindle rod 11 in a rotation-resistant manner. The blocking according to the invention of the rotatability of the spindle rod 11 is achieved by latching the locking means 25 into the indentations provided on the outer circumference of the locking element 30.

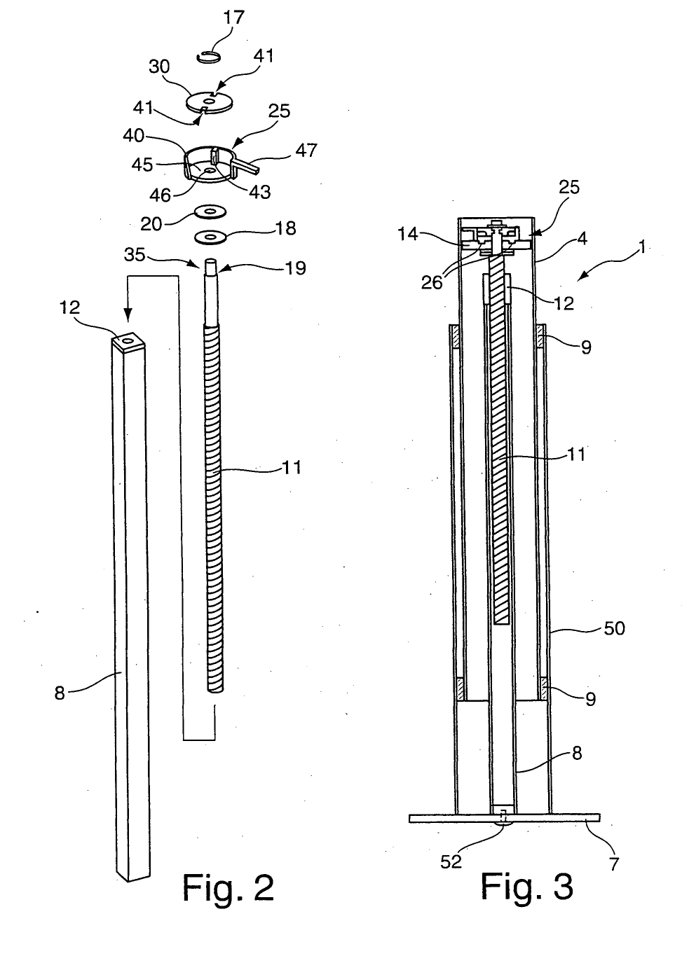

FIG. 2 shows an exploded view of an embodiment of the locking means 25 for blocking the rotatability of the spindle rod 11 of a support according to the invention. The support column 8 of the support has the outer form of an elongated cuboid on the one end of which a screw-nut-like end piece, i.e. a spindle nut 12 with a motion thread, is fixed, e.g. welded or plugged in. The spindle rod 11 of the support is to be screwed into this end piece, as is indicated in the figure in a symbolized manner by an arrow. The spindle rod 11 is guided in the support column 8 by means of its motion thread in a non-self-locking manner via the thread of the end piece.

A supporting edge 19 is provided at a free end area of the spindle rod 11, which protrudes out of the support column 8 even when the spindle rod 11 has been completely screwed in, so that the spindle rod 11 narrows in the free end area. The narrowed area 35 of the free end is intended for pushing the spindle rod 11 through the boring of a spindle mating part, e.g. a support plate (not shown in the figure) to secure the spindle rod against axial displacement relative to the tube profile.

A locking disk 18 and a sliding disk 20 are plugged onto the narrowed area 35 before pushing the free end area of the spindle rod 11 through the bore. The locking disk 18 serves for better support of the sliding disk 20 to further reduce the diminished friction between the spindle rod 11 and the spindle mating part.

After having pushed the free end area of the spindle rod 11 through the bore, the locking means 25 and finally a locking ring 17 are plugged onto the narrowed area 35. The locking ring 17 prevents the spindle rod 11 from being pushed out or slid out of the bore.

The locking means 25 comprise an elastic element 40 designed as a ring element which encompasses a locking element 30 designed as a locking disk for blocking the rotatability of the spindle rod 11, and which is plugged onto the spindle rod 11 in a rotation-resistant manner. The locking disk has two indentations 41 on its outer circumference, into which a pin 43 of the ring element engages or can engage.

Since the ring element has a disk-like base 45 with a central bore 46, the ring element can simply be plugged onto the narrowed area 35 of the spindle rod 11 to be arranged centrally and radially around the free end area of the spindle rod 11. One ring segment is omitted on the ring-shaped part of the ring element so that the ring-shaped part has two ends. The ring-shaped part is fixed to the base 45 only at one end so that the ring element (e.g. elastic plastic) can be widened by activating a trigger 47 designed as a lever extension provided on the other end. With the trigger 47, the inner circumference of the ring element can thus be widened so that the pin 43, which is positioned on the inner circumference side of the ring element projecting radially inwards, can be unlatched from the indentation 41, i.e. when it is latched into the indentation 41, to release the rotatability of the spindle rod 11. By releasing the trigger 47 (elastic restoring force), the inner circumference of the ring element is once more reduced due to its elasticity, pressing the pin 43 onto the outer circumference of the locking disk 30 so that this automatically latches into the next indentation of the locking disk 30 when the spindle rod 11 is turned by pulling it out of or pressing it into the support column 8, thus blocking the rotatability of the spindle rod 11.

FIG. 3 shows another embodiment of a support 1 according to the invention with the mechanism for locking the rotatability of the spindle rod 11 of FIG. 2. The tube profile 4 is designed as a telescopic inner profile guided in an outer profile 50 via sliding guides 9. The outer form of the support 1 according to the invention is formed by the inner profile and the outer profile 50 so that the height adjustment mechanism described in FIG. 2 is arranged within the outer sleeve of this design. The diameter of the outer sleeve is considerably larger than the diameter of the support column 8. A ground plate 7 is fixedly connected to the outer profile 50 at the end of the support 1 to be arranged on the floor. The end of the support column 8 facing away from the spindle nut 12 is fixed to the ground plate 7 in a rotation-resistant manner via a fixing screw 52. The locking means 25 designed as a ring element seats on the spindle mating part 14 which is designed as a support plate and which is welded to the inner tube rotation-resistant, via pins 26.

If a rotation-resistant guide of the inner profile in the outer profile 50 is provided (e.g. via sliding guides 9 not radially rotatable or tubes with an edged outer profile), a rotation-resistant guiding of the support column 8 in the tube profile 4, i.e. the inner profile, is achieved via the rotation-resistant fixing of the outer profile to the support column 8 via the ground plate 7.

Proposed is a length-adjustable, in particular, height-adjustable support 1 with
a tube profile 4 preferably designed as cylinder profile,
a telescopic support column 8 guided in the tube profile 4, and
a spindle rod 11 which is guided in the support column 8 via a motion thread and mounted in a rotatable manner in the tube profile 4 in a free end area of the spindle rod 11, projecting out of the support column 8 and secured against axial displacement relative to the tube profile 4 via locking means. The locking means 25 are designed to block the radial rotatability of the spindle rod 11 with respect to the tube profile 4.

The invention is not restricted to the embodiments described above. There is rather a number of variants conceivable which make use of the characteristics of the invention even in substantially different designs.

We claim:

1. A length-adjustable or height-adjustable support comprising:
a tube or cylinder profile;
a telescopic support column guided in said tube or cylinder profile;
a spindle rod guided in said support column via a motion thread and mounted in a rotatable manner in said tube profile at a free end area of said spindle rod projecting out of said support column;
first locking means, cooperating with said tube or cylinder profile and with said free end area of said spindle rod, for securing said spindle rod against axial displacement relative to said tube or cylinder profile; and
second locking means, cooperating with said tube or cylinder profile and with said free end area of said spindle rod, for blocking a rotation of said spindle rod relative to said tube profile.

2. The length-adjustable support of claim 1, wherein said second locking means have at least one indentation fashioned in said end area on an outer circumference of said spindle rod or fashioned in a latching element mounted in a rotation-resistant manner to said end area of said spindle rod, a blocking of rotation of said spindle rod relative to said tube or cylinder profile being achieved via latching of at least one pin, disposed on said second locking means, into said indentation.

3. The length-adjustable support of claim 2, wherein said second locking means have an elastic element mounted in a rotation-resistant manner in said tube or cylinder profile and which can be elastically deformed by activating a trigger, wherein said pin is unlatched from said indentation to permit rotation of said spindle rod in said tube or cylinder profile in response to elastic deformation of said elastic element.

4. The length-adjustable support of claim 2, wherein said trigger projects out of said tube or cylinder profile.

5. The length-adjustable support of claim 3, wherein said elastic element is designed as a ring element and is disposed radially around said free end area of said spindle rod, said trigger being designed as a lever extension disposed on said ring element for widening an inner circumference of said ring element, said pin being positioned on an inner circumference side of said ring element and projecting radially inwards, wherein widening of said ring element unlatches said pin from said indentation to permit rotation of said spindle rod.

6. The length-adjustable support of claim 1, wherein said second locking means have a spindle mating part fixed in a rotation-resistant manner to said tube or cylinder profile and having a bore through which said spindle rod passes, and with a locking ring structured and disposed to prevent a pushing-out of said spindle rod from said bore at a free end of said end area of said spindle rod, wherein a supporting edge at a spindle-sided end of said end area of said spindle rod blocks a pushing of said spindle rod into said bore.

7. The length-adjustable support of claim 6, wherein a sliding washer is disposed between said supporting edge and said spindle mating part.

8. The length-adjustable support of claim 1, wherein said tube or cylinder profile is designed as a telescopic inner profile guided in an outer profile.

9. The length-adjustable support of claim 8, wherein said tube or cylinder profile is guided in said outer profile via sliding guides.

10. The length-adjustable support of claim 8, wherein said support column is designed in a substantially rotation-resistant manner relative to said tube or cylinder profile.

11. The length-adjustable support of claim 10, wherein rotation-resistant guide of said support column in said tube or cylinder profile is achieved via a rotation-resistant guiding of said inner profile in said outer profile and a rotation-resistant fixing of said outer profile to said support column.

12. A table having at least one table leg comprising the length-adjustable support of claim 1.

13. The table of claim 12, wherein said second locking means of said support are positioned in an area of said table leg adjoining a tabletop of said table.
